(19) United States
(12) Patent Application Publication
(10) Pub. No.: US 2007/0028253 A1
(43) Pub. Date: Feb. 1, 2007

(54) Disk loading apparatus

(75) Inventors: Katsuyuki Yokota, Daito (JP); Masahiro Ando, Daito (JP); Kazumasa Tsujihara, Daito (JP)

Correspondence Address: BACON & THOMAS, PLLC, 625 SLATERS LANE, FOURTH FLOOR, ALEXANDRIA, VA, 22314, US

(73) Assignee: FUNAI Electric Co., Ltd., Daito (JP)

(21) Appl. No.: 11/492,038

(22) Filed: Jul. 25, 2006

(30) Foreign Application Priority Data
Jul. 26, 2005 (JP) 2005-215685

(51) Int. Cl. G11B 17/04

(52) U.S. Cl. 720/620

(57) ABSTRACT

There is provided a disk loading apparatus capable of centering and loading a disk reliably with a simple structure. There is provided an anti-sinking rib protruding forward from the outer peripheral surface in the lower end portion of each boss of a disk stopper 6, that is, toward an insertion slot 4a. That is, anti-sinking ribs 6aa, 6ba, and 6da are provided, respectively, on the bosses 6a, 6b, and 6d. These anti-sinking ribs have a function of receiving the inserted disk at the lower end portion of each boss so that the disk may not get into under the disk stopper 6.

### BACKGROUND OF THE INVENTION

1. Field of the Invention

The present invention relates to a disk loading apparatus for holding a disk such as a CD or DVD and placing the disk on a turntable.

2. Description of the Prior Art

As an example of a disk player for performing recording or reproduction onto/from such a disk, there has conventionally been known one including a so-called slot-in type disk loading apparatus in which when a disk is inserted through a disk insertion slot provided on the outer surface of a casing, the disk is carried automatically to a predetermined position.

Such a disk player is adapted to move a disk inserted by the disk loading apparatus through the insertion slot to a predetermined position on a turntable and to cause a damper to fix and hold the disk on the turntable. It is then arranged that the disk is to be rotated by driving and rotating the turntable, and that a signal is to be written or read into/from the recording surface of the rotating disk through a pickup.

FIG. 3 is a schematic plan view of a conventional disk loading apparatus. As shown in the figure, in the disk loading apparatus of the present example, a flap not shown in the figure is installed back and forth rotatably in the front part of a chassis 4 in a seesaw manner, and a turntable 5 is disposed in the vicinity of the center thereof, while an approximately long plate-shaped disk stopper 6 is disposed at the back of the turntable. At the respective left and right ends of the disk stopper 6, there are provided approximately cylindrical bosses 6a and 6b extending downward from the undersurface of the disk stopper. Also, at the center of the disk stopper 6, there is provided a guide rib 6c for serving as a guide when the disk stopper 6 slides back and forth.

Here will be described the operation when a small-diameter disk having a diameter of 8 cm is inserted. As shown in the figure, when the small-diameter disk 2 is inserted through an insertion slot 4a formed in the front part of the chassis 4, the disk 2 is sandwiched between the flap not shown in the figure and a roller 3 provided beneath the flap, and when the roller 3 is rotated in this state, the disk 2 is drawn into the chassis 4. It is noted that the figure shows the case where the small-diameter disk 2 is inserted to the right with respect to the insertion slot 4a.

Here, the roller 3 is provided in the front part of the chassis 4 in a laterally extended manner and is capable of carrying also a large-diameter disk having a diameter of 12 cm. Then, the roller is formed in a so-called approximately drum-like shape in which the diameter is increased gradually in a tapered manner from the central part having a relatively small diameter toward both the left and right sides. This shape causes the disk 2 to be carried by the rotation of the roller 3 to be subject to an inward force with respect to the direction perpendicular to the carrying direction. It is therefore possible to center the disk 2 based on the shape of the roller 3 when carried by the roller 3 even if may be misaligned laterally during insertion.

Then, the disk 2 inserted to the right with respect to the insertion slot 4a is carried into the chassis 4 and brought into contact with the boss 6b that is provided in the right end portion of the disk stopper 6. In this state, the disk 2 starts rotating due to centering. Subsequently, the disk 2 is carried in the inward direction and then fitted to the disk stopper 6 to complete the centering. Further, the disk 2 is carried deeper into the chassis 4, which presses the disk stopper 6 to trigger the start of chucking.

In the case above, since the center hole of the disk 2 is positioned directly above the turntable 5, when a damper not shown in the figure gets down, the disk 2 is sandwiched between the damper and the turntable 5 to complete the chucking. It is noted that even if the disk 2 may be inserted to the left with respect to the insertion slot 4a, there is only a left-right reversal of the operation of the disk 2 to perform centering and chucking in the same way.

As mentioned above, in the conventional so-called slot-in type disk loading apparatus, even if a small-diameter disk may be misaligned laterally during insertion, the disk can be centered and chucked smoothly. Also, there are even less problems with the loading operation of a large-diameter disk.

In addition to above, Japanese Patent Laid-Open Publication No. 2002-313007 discloses a recording medium reproduction apparatus capable of preventing a recording medium from being displaced from a carriage path. Specifically, there are provided, for example, guide means for guiding a disk-shaped recording medium to a reproducing position along the carriage path, prevention means for preventing a small-diameter disk-shaped recording medium from being displaced from the carriage path, and restriction means for restricting the displacement of the prevention means so that the small-diameter disk-shaped recording medium is positioned within the carriage path when carried.

In addition, Japanese Patent Laid-Open Publication No. 2000-187913 discloses a disk clamping apparatus for clamping a disk inserted in a reproduction apparatus constantly to prevent the disk from being misaligned or displaced until the disk is transferred to a reproducing position. Specifically, there are provided a roller portion for transferring a disk to the reproducing position, a clamping portion including a damper for clamping and holding the disk from above that is transferred by the roller portion to the reproducing position, and a slider engaged with the clamping portion and the roller portion for clamping operation so that the disk inserted in the reproduction apparatus is held constantly.

However, with such a conventional arrangement as shown in FIG. 3, the inserted disk may get into under the disk stopper 6, where the disk is to be carried deeper into the chassis 4 without being positioned properly, resulting in a chucking error. Further, there is a possibility that the disk cannot be ejected from the apparatus and/or may be damaged.

In addition to above, the arrangements described in Japanese Patent Laid-Open Publication Nos. 2002-313007 and 2000-187913 each have a complex and major structure, which may cause an increase in cost as well as troubles when produced and/or used.

### SUMMARY OF THE INVENTION

The present invention has been made in consideration of the above-described problems, and an object thereof is to provide a disk loading apparatus capable of centering and loading a disk reliably with a simple structure.

In order to achieve the foregoing object, the present invention is directed to a disk loading apparatus adapted to hold a disk inserted through an insertion slot between a flap and a roller and to carry the disk by the rotation of the roller, the apparatus having a disk stopper and being arranged in such a manner that when the disk is fitted between bosses provided at the respective left and right ends of the disk stopper, the center hole of the disk is positioned over a turntable, wherein there is provided an anti-sinking rib protruding from the lower end portion of each boss toward the insertion slot, the anti-sinking rib being adapted to receive the disk.

Also, the apparatus is characterized in that the anti-sinking rib has a slope inclined downward toward the insertion slot, the slope being adapted to scoop the leading end of the disk up to bring the disk into contact with each boss.

In accordance with the present invention, it is possible to provide a disk loading apparatus capable of centering and loading a disk reliably with a simple structure.

Specifically, since the anti-sinking rib protruding from the lower end portion of each boss provided at both the left and right ends of the disk stopper toward the insertion slot is adapted to receive the disk, the disk cannot get into under the disk stopper, which allows reliable centering and positioning and therefore prevents chucking error.

### BRIEF DESCRIPTION OF THE DRAWINGS

FIG. 1 is a schematic plan view of a disk loading apparatus according to a first embodiment of the present invention;

FIG. 2 is a view showing a disk stopper in the disk loading apparatus; and

FIG. 3 is a schematic plan view of a conventional disk loading apparatus.

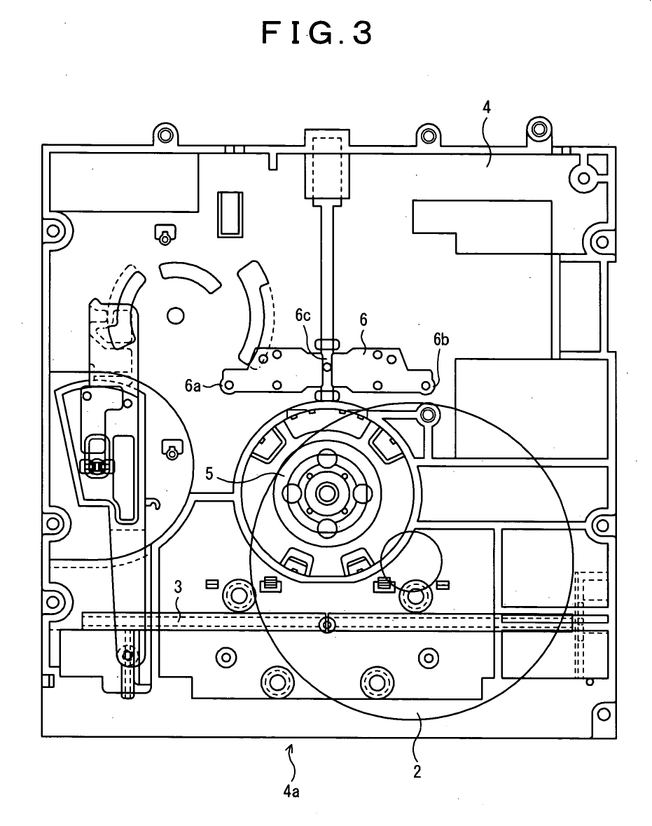

### DESCRIPTION OF THE PREFERRED EMBODIMENTS

An embodiment of the present invention will hereinafter be described with reference to the accompanying drawings. It is noted that components having the same functions as those in the conventional art are designated by the same reference numerals to omit detailed descriptions appropriately.

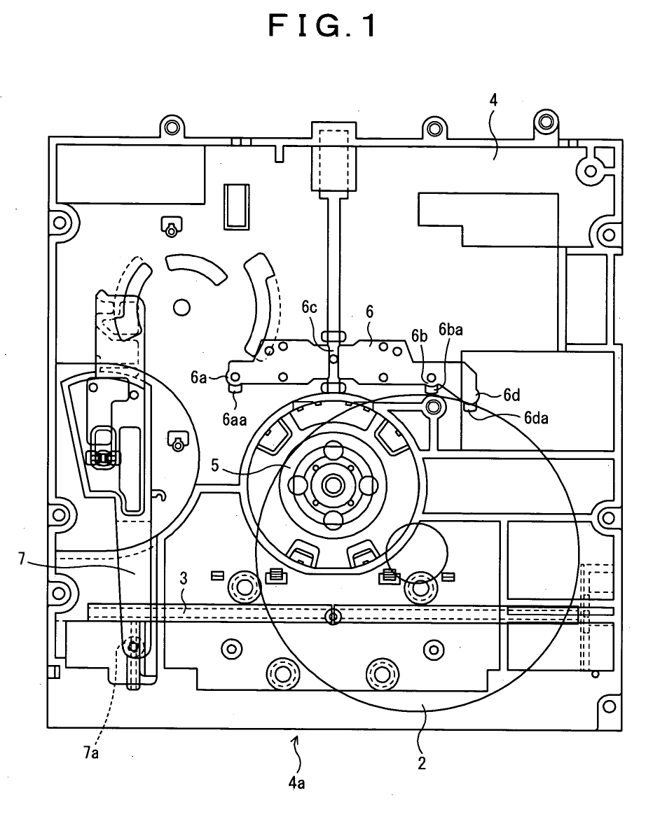

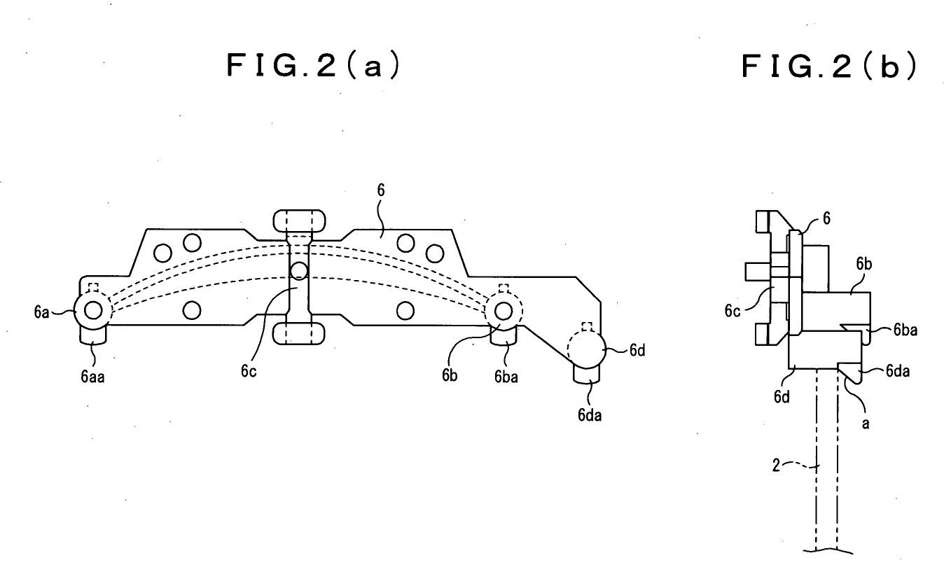

FIG. 1 is a schematic plan view of a disk loading apparatus according to a first embodiment of the present invention. Also, FIG. 2 is a view showing a disk stopper in the disk loading apparatus, where FIG. 2(a) is a plan view and FIG. 2(b) is a right side view. In the present embodiment, an anti-sinking rib is provided on each boss of the disk stopper 6 to prevent a disk from getting into under the disk stopper 6, as shown in the figures.

It is noted that in the present embodiment, the right part of the conventional disk stopper 6 is extended, and at the leading end thereof as well as on the front right of the boss 6b that is provided in the original right end portion, there is provided an approximately cylindrical boss 6d extending downward from the undersurface of the disk stopper 6, as shown in the figures. Since the boss 6d is adapted to guide the disk 2 inward, the disk can be centered and chucked smoothly.

Then, in the present embodiment, there is provided an anti-sinking rib protruding forward from the outer peripheral surface in the lower end portion of each boss, that is, toward the insertion slot 4a. That is, anti-sinking ribs 6aa, 6ba, and 6da are provided, respectively, on the bosses 6a, 6b, and 6d. These anti-sinking ribs have a function of receiving the inserted disk at the lower end portion of each boss so that the disk may not get into under the disk stopper 6.

Specifically, as shown in FIG. 2(b), each anti-sinking rib has a slope “a” inclined forward and downward. Then, the slope “a” is adapted to scoop the leading end of the inserted disk 2 up to bring the disk into reliable contact with the outer peripheral surface of each boss, as exemplified by the alternate long and two short dashes line. This prevents the disk from getting into under the disk stopper 6.

Then, since the disk is in contact with the vicinity of the central part of each boss in the longitudinal direction (vertical direction) and cannot be in contact with the lower end portion of each boss as in the conventional art, only a small load is to be applied to the upper end portion, that is, the base portion of each boss continuing into the disk stopper 6. Thus, there is no possibility that each boss is inclined to cause the disk to drop out of the disk stopper 6 as in the conventional art. Also, since the disk is kept approximately horizontal in this state, the disk is held reliably between the flap not shown in the figures and the roller 3 to be carried smoothly.

As described heretofore, in accordance with the present embodiment, the disk cannot get into under the disk stopper, which allows for reliable centering and positioning and therefore prevents chucking error. In addition to this, since each anti-sinking rib protrudes only forward from each boss and there is no so-called undercut portion with respect to the disk stopper 6, there is no need to use a sliding structure, etc. when producing a resin-molding die, which allows a reliable structure that is also advantageous in cost terms.

It is noted that as shown in FIG. 1, an arm-shaped disk selector 7 is provided in the left part of the chassis 4 in an anteroposteriorly extended manner, and there is provided an approximately cylindrical boss 7a extending downward from the undersurface in the front end portion of the selector, in which it is determined whether the inserted disk has a small or large diameter based on the state where the boss 7a is pressed by the disk.

What is claimed is:

1. A disk loading apparatus adapted to hold a disk inserted through an insertion slot between a flap rotatable in a seesaw manner and a roller formed in an approximately drum-like shape and to carry said disk to a turntable by the rotation of said roller while performing centering,
said apparatus having a disk stopper positioned at the back of said turntable and being arranged in such a manner that when said disk is fitted between bosses provided at the respective left and right ends of said disk stopper, the center hole of said disk is positioned over said turntable, wherein
there is provided an anti-sinking rib protruding from the outer peripheral surface in the lower end portion of said each boss toward said insertion slot, said anti-sinking rib being adapted to receive said disk and having a slope inclined downward toward said insertion slot, said slope being adapted to scoop the leading end of said disk up to bring said disk into contact with the outer peripheral surface of said each boss.

2. A disk loading apparatus adapted to hold a disk inserted through an insertion slot between a flap and a roller and to carry said disk by the rotation of said roller,
said apparatus having a disk stopper and being arranged in such a manner that when said disk is fitted between bosses provided at the respective left and right ends of said disk stopper, the center hole of said disk is positioned over a turntable, wherein
there is provided an anti-sinking rib protruding from the lower end portion of said each boss toward said insertion slot, said anti-sinking rib being adapted to receive said disk.

3. The disk loading apparatus according to claim 2, wherein said anti-sinking rib has a slope inclined downward toward said insertion slot, said slope being adapted to scoop the leading end of said disk up to bring said disk into contact with said each boss.
